(19) United States
(12) Patent Application Publication
(10) Pub. No.: US 2018/0332866 A1
(43) Pub. Date: Nov. 22, 2018

(54) SYSTEM AND METHOD FOR SMOKE VACUUM PACKAGING

(71) Applicant: Henkelman Inc., Elmhurst, IL (US)

(72) Inventor: David Mahan, Warren, OH (US)

(21) Appl. No.: 15/949,187

(22) Filed: Apr. 10, 2018

Related U.S. Application Data
(60) Provisional application No. 62/508,680, filed on May 19, 2017.

(51) Int. Cl. A23B 4/052; B65B 31/02

(52) U.S. Cl. CPC A23B 4/052; A23V 2002/00; B65B 31/024

(57) ABSTRACT

Embodiments of the invention provide systems and methods of smoke vacuum packaging. A method of smoke vacuum packaging includes the steps of removing a substantial amount of air from a container in which a product is positioned, infusing the container with smoke after a substantial amount of air is removed from the container, and sealing the container.

### CROSS-REFERENCE TO RELATED APPLICATIONS

The present application claims the benefit of U.S. Provisional Application Ser. No. 62/508,680, the disclosure of which is hereby incorporated by reference.

### SUMMARY

The present application generally relates to vacuum packaging devices and, more particularly, relates to vacuum packaging devices capable of infusing smoke into a product during the vacuum packaging process.

Some embodiments of the invention provide a method of vacuum smoke packaging, the method comprising the steps of removing a substantial amount of air from a container in which a product is positioned, infusing the container with smoke after a substantial amount of air is removed from the container, and sealing the container.

In some embodiments, the method further includes the step of placing the container within a chamber in a vacuum packaging device. In some embodiments, the removing step further includes the step of removing a substantial amount of air from the container and the chamber within the vacuum sealing device. In some embodiments, the method further includes the step of releasing the vacuum within the vacuum sealing device, thereby allowing air to enter the chamber within the vacuum packaging device. In some embodiments, the infusing step further includes the steps of creating smoke within a smoke creation device by burning at least one substance and moving the smoke from the smoke creation device, through a conduit, and into the container. In some embodiments, the product is food.

Some embodiments of the invention provide a smoke vacuum packaging device comprising a vacuum packaging device having a chamber formed by a housing of the vacuum packaging device, a sealing device positioned within the chamber and configured to seal a container, a vacuum device coupled to the vacuum packaging device and configured to create a vacuum within the chamber, a smoke creation device coupled to the vacuum packaging device, the smoke creation device configured to create smoke from at least one substance, and a smoke delivery device coupled to the smoke creation device and configured to move smoke from the smoke creation device into the chamber of the vacuum packaging device.

In some embodiments, the smoke creation device is separate from the vacuum packaging device. In some embodiments, the smoke vacuum packaging device further includes a conduit positioned between the smoke creation device and the vacuum packaging device, wherein the smoke delivery device is configured to move smoke through the conduit. In some embodiments, the smoke creation device is integral with and positioned within the vacuum packaging device. In some embodiments, the smoke delivery device is a fan.

Some embodiments of the invention provide a method of vacuum smoke packaging, the method comprising the steps of removing air from an area around a product and infusing the area around the product with smoke.

In some embodiments, the steps of removing and infusing may be repeated at least once. In some embodiments, the product is a food product. In some embodiments, the removing and infusing steps are accomplished with the product positioned within a chamber. In some embodiments, the removing and infusing steps are accomplished with the product positioned within a container.

### DESCRIPTION OF THE DRAWINGS

FIG. 1 is a cross-sectional view of a system for smoke vacuum packaging, the system generally including a vacuum packaging device, a smoke creation device, and a vacuum forming device, the vacuum packaging device being shown with a lid thereof in an open position and a food product or other item being placed within the vacuum packaging device;

FIG. 2 is a cross-sectional view of the system of FIG. 1 with the lid in a closed position and with the smoke creation device and the vacuum forming device removed for simplicity;

FIG. 3 is a cross-sectional view of the system of FIG. 1 with the lid in a closed position and showing air being pulled out of the vacuum packaging device (by the vacuum forming device), with the smoke creation device and the vacuum forming device removed for simplicity;

FIG. 4 is a cross-sectional view of the system of FIG. 1 with the lid in a closed position and depicting smoke being moved or forced into a container in which the food product or other item is positioned, the smoke creation device and the vacuum forming device being removed for simplicity;

FIG. 5 is a cross-sectional view of the system of FIG. 1 with the lid in a closed position and depicting a mouth of the container being sealed, with the smoke creation device and the vacuum forming device removed for simplicity;

FIG. 6 is a cross-sectional view of the system of FIG. 1 with the lid in a closed position and depicting release of the vacuum within the vacuum packaging device, the smoke creation device and the vacuum forming device being removed for simplicity;

FIG. 7 is a flow chart depicting an exemplary method for smoke vacuum packaging of the present application;

FIG. 8 is a cross-sectional view of a further embodiment of a system for smoke vacuum packaging, the system generally including a vacuum packaging device, a smoke creation device, and a vacuum forming device, the smoke creation device depicted as being integral or within the same housing as the vacuum packaging device.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

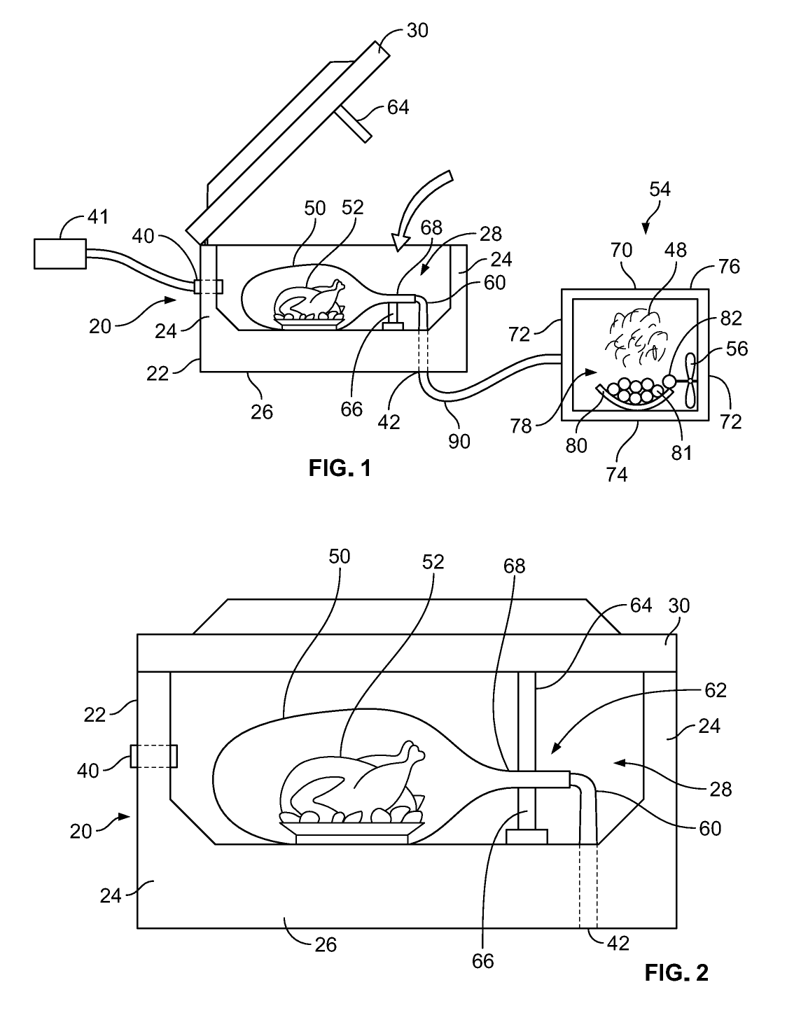

FIG. 1 depicts an illustrative embodiment of a vacuum packaging device 20 of the present application. The vacuum packaging device 20 may include a housing 22, which may be a rigid, semi-rigid, or flexible container. The device 20 may generally include a number of different walls, for example, four side walls 24 and a bottom wall 26 forming a chamber 28, and a lid 30 attached to one of the side walls 24 for selective access to the chamber 28. Optionally, the lid may be formed in any one of the walls and/or access into the chamber may be provided in any other suitable manner. It should be understood that the size, shape, orientation, and/or other features of the vacuum packaging device 20 may be modified without departing from the scope of the present application.

Still referring to FIG. 1, the vacuum packaging device 20 may further include an outlet 40 through which air is sucked or pulled (e.g., by a vacuum, suction pump, or other vacuum forming device 41) during the creation of a vacuum within the chamber 30. The outlet 40 may be formed through any one of the side walls 24 or the bottom wall 26 or may be formed in any other suitable manner. Further, although one outlet 40 is depicted, a number of outlets for pulling air from the chamber 30 may be utilized. Additionally, although the outlet 40 is shown as being connected to an outside vacuum source, the vacuum source may optionally be included within the housing 22.

The vacuum packaging device 20 may further include an inlet 42 for supply of smoke 48 (see FIG. 4) into a bag or other container 50 in which a food product or other item 52 is positioned. An exemplary food product is meat, but any food product may be infused with smoke 48 utilizing the apparatuses and methods of the present application. Further, while food products are discussed throughout, the apparatuses and method of the present application may also be utilized for non-food products, such as for example, plastic items, cardboard items, paper items, knit items, foam items, fabric items, or any other suitable items, for example, items with an open cell structure or a structure that would allow the items to absorb vapors or gases. While the container 50 is discussed herein as being a bag, the container may be any other suitable container, for examples a plastic container, a jar, or any other suitable container that may be vacuum packaged. As will be discussed in greater detail below, smoke 48 may be supplied from smoke creation device 54 by a smoke delivery device 56 to the inlet 42. In other illustrative embodiments, smoke 48 may be drawn or sucked into the vacuum packaging device 20 due to differential pressure (i.e., a vacuum environment in the vacuum packaging device 20 tends to pull air, smoke, etc. from the smoke creation device 54 due to the difference in pressure). The inlet 42 may be formed through any one of the side walls 24 or the bottom wall 26 or may be formed in any other suitable manner. In illustrative embodiments, a conduit 60 may be coupled to the inlet 42, formed in or by the housing 22, and extend into the chamber 28, such that the conduit 60 may extend into the bag 50 to infuse the bag 50 with smoke.

The term smoke is utilized herein to refer to vapor(s) and/or gas(es) given off by burning or smoldering a substance. The substance that is burned may be one or more substances that may have an aroma or flavor that one might desire to be infused into the food product or other item 52. Examples of substances include, but are not limited to, tea leaves, wood chips, pellets, coffee grounds, lemon, lime, orange, or other citrus peels, a skin of any fruit or vegetable, oils (e.g., oil, sunflower, coconut, etc.), aromatics, fragrances, deodorizers, marijuana, herbs (e.g., basil, oregano, cilantro, thyme, rosemary, ginger, or any other herbs), nuts, perfumes, or any other suitable substances that have an aroma or flavor that one might desire to be infused in the food product or other item 52, or combinations thereof.

The vacuum packaging device 20 may include a sealing device 62, for example, with upper and lower sealing elements 64, 66, for sealing a mouth 68 or other portion of the bag 50 (or other flexible container). While the upper sealing element 64 is depicted as being coupled to the lid 30 and the lower sealing element 66 is depicted as being coupled to the bottom wall 26, the sealing device 62 may be positioned at any suitable location within the vacuum packaging device 20 and/or may include any suitable number of sealing elements. As seen in FIG. 1, in illustrative embodiments, the mouth 68 of the bag 50 is placed around an end of the conduit 60 to allow smoke to enter the bag 50 through the conduit 60 and additionally to position the mouth 68 of the bag 50 in relation to the sealing elements 64, 66 such that the bag 50 may be sealed after infusion with smoke, as will be discussed in greater detail below. In embodiments in which the container 50 is not a bag, the sealing device 62 with sealing elements 64, 66 may be replaced with any sealing device, for example, a device that attaches a lid or cover to a rigid or semi-rigid container, a device that covers an opening of a container, or any other suitable device capable of enclosing a container. In other illustrative embodiments, a sealing device is not necessary, for example, in a self-closing/sealing device (e.g., a can with a lid having a sealing rubber may keep itself closed when a vacuum has been drawn, a container having a plastic self-closing valve, etc.).

As best seen in FIG. 1, the smoke creation device 54 generally includes a housing 70, which may be a rigid, semi-rigid, or flexible container. In an exemplary embodiment, the smoke creation device 54 generally include a number of different walls, for example, four side walls 72, a bottom wall 74, and a top wall 76 all forming a chamber 78. The housing 70 may be made of any suitable material, preferably one resistant to heat and/or fire, for example, steel or other metal. The housing 70 may include an access opening (not shown) for inserting substances to be burned within the smoke creation device 54. While the housing 70 is generally shown as being box-shaped, the housing 70 may take any suitable shape or form.

In illustrative embodiments, the smoke creation device 54 may include an optional receptacle 80 positioned within the chamber 78 for depositing one or more substances 81 to be burned therein. In other embodiments, one or more substances 81 may be placed directly on a surface within the housing 70. The smoke creation device 54 may additionally include an ignitor 82, for example, in the form of a flame or any other suitable ignitor 80 that can be selectively activated to ignite and burn the one or more substances 81 within the receptacle. While an ignitor 82 is depicted within the smoke creation device 54, the smoke creation device 54 need not include an ignitor 82. For example, in some illustrative embodiments, a user may utilize a match, lighter, or other ignitor to manually ignite the one or more substances 81. The smoke creation devices 54 further includes a smoke delivery device 56, for example, in the form of a fan 56. In other embodiments, the smoke delivery device 56 may be a blower or any other suitable device or condition, for example, differential pressures between the vacuum packaging device 20 and the smoke creation device 45, capable of moving smoke from a first location to a second location. The fan 56 moves the smoke within the smoke creation device 54 from the housing 70 to the vacuum packaging device 20. In some illustrative embodiments, the smoke is moved through a conduit 90 from the smoke creation device 54, through the inlet 42 and conduit 60 within the vacuum packaging device 20, and into the bag 50.

The smoke creation device 54 may include any number of additional features including, for example, one or more controls to adjust or regulate an amount of smoke provided to the vacuum sealing device (e.g., a fan adjustment controller to control a fan speed or other characteristic of the fan, a valve or other adjuster (for example, in communication with the inlet 42, the conduit 60, and/or the conduit 90)), an ignitor control, or any other suitable adjustment mechanism. It should also be understood that other manual or electronic controls may be utilized to adjust an amount of smoke provided to the vacuum sealing device, for example, an amount of the one or more substances 81 provided in the smoke creation device 54 and/or other controls. In other words, any function or feature of the system for smoke vacuum packaging may be adjustable through electronic controls or manually.

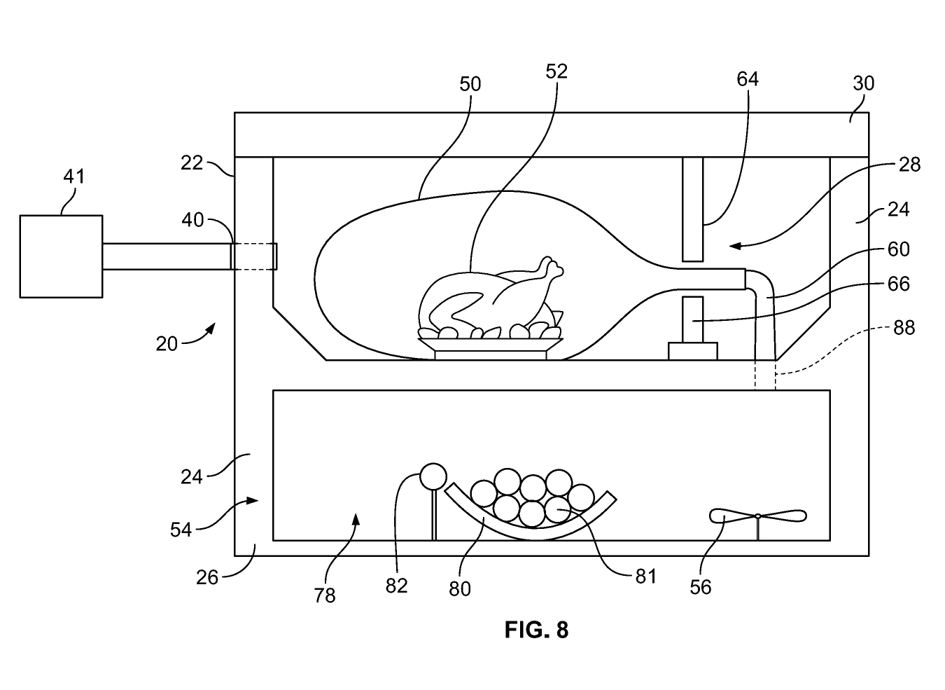

While the smoke creation device 54 is shown as being separate from and connected to the vacuum packaging device 20, the smoke creation device 54 may optionally be formed integrally with or as part of the vacuum packaging device 20, as seen in FIG. 8. In this manner, the vacuum packaging device 20 may include a smoke creation device 54 incorporated within the housing 22 and a conduit 88 for selectively moving smoke 48 from the smoke creation device 54 to the chamber 28 in which the vacuum packaging and smoke infusion occurs. In such an embodiment, the smoke creation device 54 may include the same features and components as described above with respect to FIG. 1. Still further, while the smoke creation device 54 and conduit 90 are only shown in FIG. 1, the smoke creation device 54 and conduit 90 are not shown in FIGS. 2-6 for the sake of simplicity. It should be understood that the smoke creation device 54 and conduit 90 are also part of the system depicted in FIGS. 2-6.

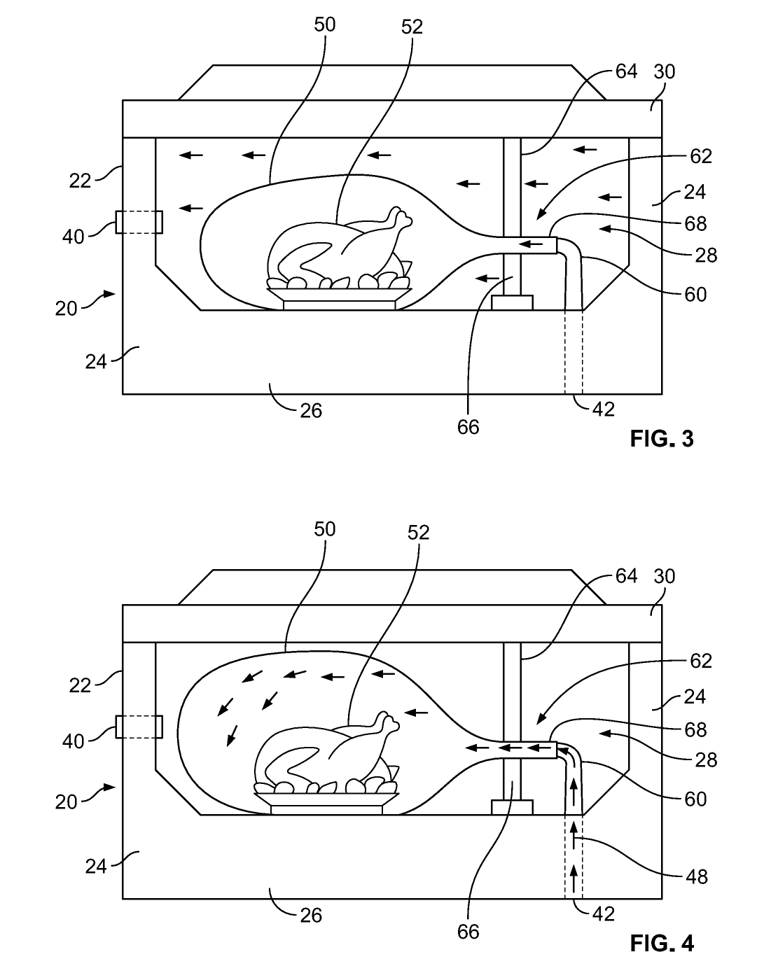

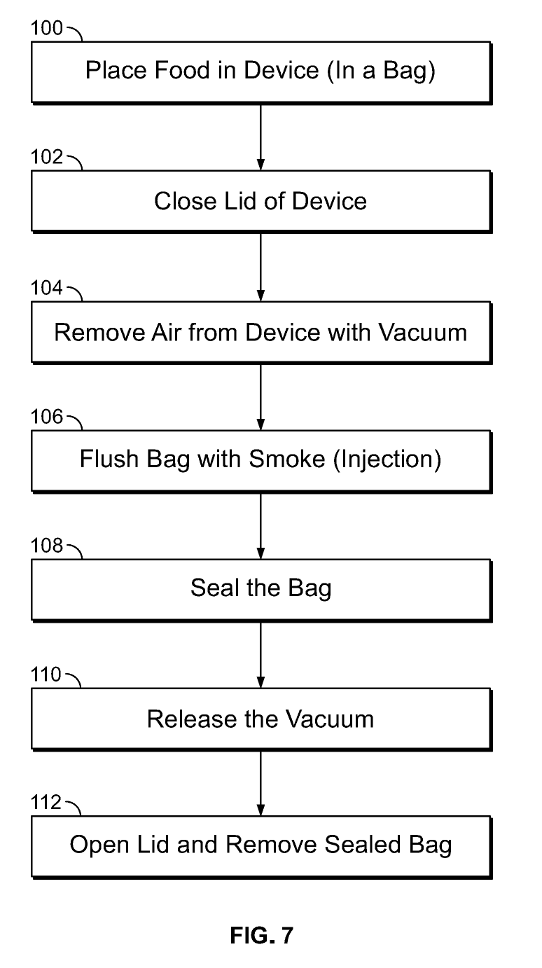

The method of smoking and packaging a food product or other item 52 will now be described with reference to FIGS. 1-6 in combination with the flow diagram of FIG. 7. At block 100 of FIG. 7, the food product or other item 52 within a bag 50 (or other container) is positioned within the chamber 28 of the vacuum packaging device 20, as seen in FIG. 1 and, thereafter, at block 102, the lid 30 of the vacuum packaging device 20 is closed with the mouth 68 of the bag 50 positioned between the upper and lower sealing elements 64, 66 of the sealing device 62 (see FIG. 2). At block 104, a portion or a substantial amount of the air (e.g., between about 30% and about 99% or between about 70% and about 90%) within the chamber 28 is removed utilizing, for example, a vacuum or suction pump (see FIG. 3). Removal of a substantial amount of the air within the chamber 28 creates a vacuum within the chamber 28, which may open up fibers, cells, and/or pores of the food product or other item 52, thereby allowing substances to enter the open fibers, cells, and/or pores of the food product or other item 52. Once a substantial amount of the air within the chamber 28 has been removed, the bag or other container 50 is flushed or injected with smoke at block 106 (see FIG. 4). More particularly, smoke from the smoke creation device 54 is moved or forced through the conduits 90, 60 and into the bag or other container 50. Infusion of smoke into the vacuum packaging device 20 is stopped when a valve positioned between the vacuum packaging device 20 and the smoke creation device 54 (e.g., along the conduit, at the inlet 42, or at any other suitable location) is closed. The valve may be operated by any suitable circuitry and/or machine code. Opening and closing of the valve may be controlled by machine code or may be controlled manually. In some embodiments, the valve may be controlled (i.e., opened and closed) when the system is at a particular pressure (e.g., the infusion may begin when a vacuum of 99% is reached and infusion may cease when the vacuum of 40% is reached).

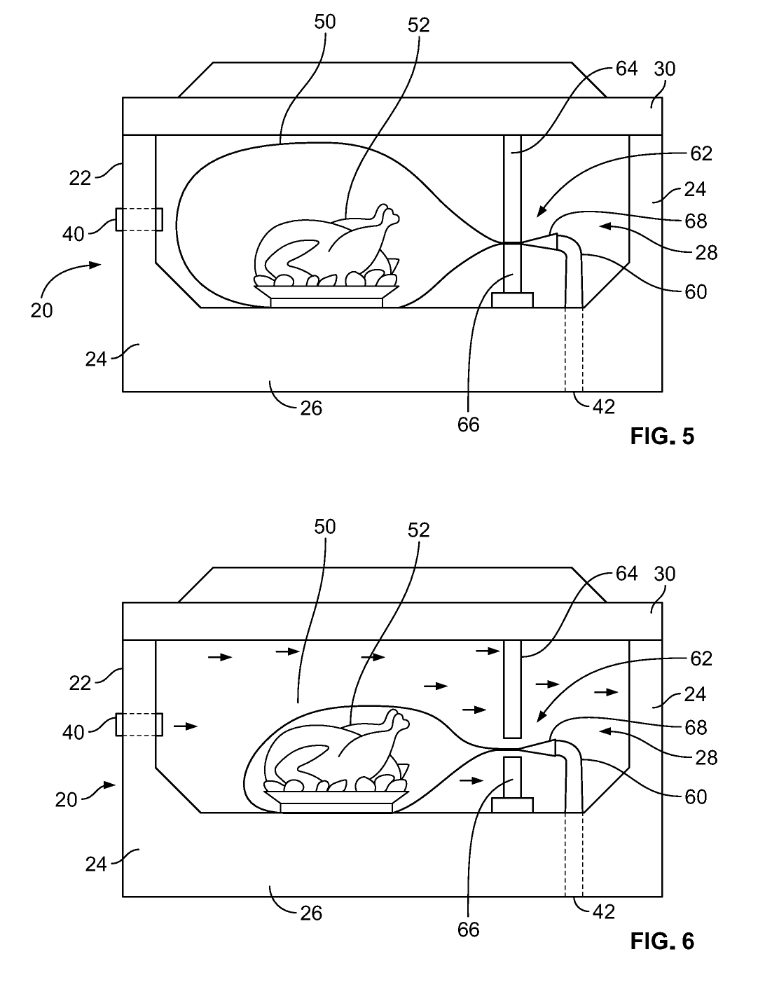

In some illustrative embodiments, steps 104 and 106 may be repeated any suitable number of times. Once the bag or other container 50 is filled with smoke, the mouth 68 of the bag 50 is sealed utilizing the upper and lower sealing elements 64, 66 at block 108 (see FIG. 5). After the bag 50 is sealed, the vacuum is released and air is allowed into the chamber 28 of the vacuum packaging device 20 at block 110 (see FIG. 6). As the chamber 28 of the vacuum packaging device 20 begins to reach atmospheric pressure, the fibers, cells, and/or pores of the food product or other item 52 within the chamber 28 begin to close with the smoke sealed or trapped within the pores, thereby saturating the food product or other item 52 with smoke. The bag or other container 50 will also include smoke that will encompass the food product or other item 52. At block 112, the lid 30 may again be opened to remove the vacuum sealed bag with smoke infused food product or other item therein.

While FIG. 7 depicts a number of different potential method steps, one or more of the steps may be omitted, replaced, and/or modified. For example, while the vacuum packaging device 20 is shown as being an in-chamber device that removes air from a bag or other container, the principles of the present application may be utilized with an out-of-chamber device (i.e., no chamber). In such an embodiment, the vacuum would be created within the bag or other container 50 by removing a substantial amount of the air contained therein and injecting the smoke 48 into the bag or other container 50 after all or most of the air has been removed therefrom. The bag or other container 50 is thereafter sealed. In a method utilizing an out-of-chamber device, the method may omit the steps of placing the food product (in a bag) within a vacuum packaging device, closing the lid, etc.

Still further, while the principles of the present application are described with respect to infusing smoke into a food product or other item 52 within a bag or other container 50, it should be understood that the methods and apparatuses disclosed herein may be utilized with a food product or other item 52 that is not positioned within a bag or other container 50. In a method of smoke vacuum packaging a food product or other item 52 without a bag or other container 50, the food product or other item 52 may be placed within the chamber 28 of the vacuum packaging device 20 (similar to FIG. 1), the lid 30 may be closed, a vacuum may be created within the vacuum packaging device 20 (similar to FIG. 3), the chamber 28 of the vacuum packaging device 20 may be infused with smoke 48 (similar to FIG. 4), and the vacuum within the chamber 20 of the vacuum packaging device 20 may be released after a period of time, allowing air into the chamber 28 (similar to FIG. 6). In such a method, one or more of the steps of creating a vacuum within the vacuum packaging device 20, infusing smoke 48 into the chamber 28, and releasing the vacuum within the chamber 28 may be completed once or may be repeated any suitable number of times.

Smoking of food products generally takes a long time, for example, 12, 24, 36 hours, in order to infuse the food products with the smoke. Smoking is generally accomplished utilizing a large, barrel-shaped smoker (or other similar device). Smokers generally include a base into which wood chips for burning are placed and one or more racks on which meat or other food is placed. The wood chips are ignited and burn at a temperature of between about 175 and about 225 degrees Fahrenheit for a longer period of time, as noted above. The systems and processes described herein eliminate the need for large smokers and dramatically reduce the time needed for smoking. In fact, the smoke vacuum packaging systems and methods disclosed herein allow for smoking a food product or other item in just a few minutes. Additionally, vacuum packaging the smoked products allow the products to be frozen or stored for a period of time, which allows more time for the smoke to infuse throughout the product.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of vacuum smoke packaging, the method comprising the steps of:
removing a substantial amount of air from a container in which a product is positioned;
infusing the container with smoke after the substantial amount of air is removed from the container; and
sealing the container.

2. The method of claim 1, further including the step of placing the container within a chamber in a vacuum packaging device.

3. The method of claim 2, wherein the removing step further includes the step of removing a substantial amount of air from the container and the chamber within the vacuum sealing device.

4. The method of claim 3, further including the step of releasing the vacuum within the vacuum sealing device, thereby allowing air to enter the chamber within the vacuum packaging device.

5. The method of claim 4, wherein the infusing step further includes the steps of:
creating smoke within a smoke creation device by burning at least one substance; and
moving the smoke from the smoke creation device, through a conduit, and into the container.

6. The method of claim 1, wherein the product is a food.

7. A smoke vacuum packaging device, the device comprising:
a vacuum packaging device having a chamber formed by a housing of the vacuum packaging device;
a sealing device positioned within the chamber and configured to seal a container;
a vacuum device coupled to the vacuum packaging device and configured to create a vacuum within the chamber;
a smoke creation device coupled to the vacuum packaging device, the smoke creation device configured to create smoke from at least one substance; and
a smoke delivery device coupled to the smoke creation device and configured to move smoke from the smoke creation device into the chamber of the vacuum packaging device.

8. The vacuum packaging device of claim 7, wherein the smoke creation device is separate from the vacuum packaging device.

9. The vacuum packaging device of claim 8, further including a conduit positioned between the smoke creation device and the vacuum packaging device, wherein the smoke delivery device is configured to move smoke through the conduit.

10. The vacuum packaging device of claim 7, wherein the smoke creation device is integral with and positioned within the vacuum packaging device.

11. The vacuum packaging device of claim 7, wherein the smoke delivery device is a fan.

12. A method of vacuum smoke packaging, the method comprising the steps of:
removing air from an area around a product; and
infusing the area around the product with smoke.

13. The method of claim 12, wherein the steps of removing and infusing are repeated at least once.

14. The method of claim 12, wherein the product is a food product.

15. The method of claim 12, wherein the removing and infusing steps are accomplished with the product positioned within a chamber.

16. The method of claim 12, wherein the removing and infusing steps are accomplished with the product positioned within a container.
